(19) United States
(12) Patent Application Publication
(10) Pub. No.: US 2009/0157506 A1
(43) Pub. Date: Jun. 18, 2009

(54) ADVERTISEMENT AUCTION METHOD, RECORDING MEDIUM THEREFOR AND ADVERTISEMENT AUCTION SYSTEM

(75) Inventor: Moon-sang Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/129,886

(22) Filed: May 30, 2008

(30) Foreign Application Priority Data
Dec. 12, 2007 (KR) 10-2007-0128752

(51) Int. Cl. G06Q 30/00

(52) U.S. Cl. 705/14

(57) ABSTRACT

Provided is a method of auctioning an advertisement provided from a server to a client. The method includes: receiving bidding information from a plurality of advertiser terminals connected to the server, the bidding information including time information which indicates what time the advertisement will appear on the client; selecting one of advertiser terminals based on the time information included in the bidding information; and transmitting advertisement content sent to the client in response to a request of the selected advertiser terminal.

### CROSS-REFERENCE TO RELATED PATENT APPLICATIONS

This application claims the priority of Korean Patent Application No. 10-2007-0128752, filed on Dec. 12, 2007, in the Korean Intellectual Property Office, the disclosure of which is incorporated herein in its entirety by reference.

### BACKGROUND OF THE INVENTION

1. Field of the Invention

Apparatuses and methods consistent with the present invention relate to an advertisement auction method and a recording medium therefor and system of auctioning an advertisement, and more particularly, to a method of auctioning advertisement which is provided to a client from a server based on a time of advertisement, and a recording medium and auction system for the method.

2. Description of the Related Art

An auction is a public sale where goods are sold to the person who offers the highest price. Generally, goods are auctioned when it is difficult to set their prices or when there has been a price change and the prices need to be newly set. Recently, auctions have been growing in popularity due to electronic commercial transactions which do not have any spatio-temporal restrictions, as compared with the traditional auctions that requires a common place and a specific time period for sellers and purchasers to participate. Auctions are conducted by using a combination of traditional auction methods for business-to-business transaction or business-to-individual transaction and computer and Internet techniques. Auction methods have been recently developed in response to computer advances and to the increase in the number of Internet users.

Auctions can be classified into a forward auction and a reverse auction. In a forward auction system, which is a conventional auction employed in a network between computers and the Internet, an image of an object to be sold is input by a supplier, the object image is showed to buyers, and the object is sold to a buyer who offers the highest bidding price. In a reverse auction system, buyers transmit their requirements to an auction provider server via their computers, and the auction provider server transmits the requirements of the buyers to suppliers connected to the server. When the suppliers who receive the requirements are willing to satisfy the requirements, they inform the server that they will participate in an auction, and the server awards a contract to the first supplier who can meet the buyer's requirements, and notifies the buyer and the supplier of the result.

In general, in an online Internet auction, bidding is determined, eligibility of participants is examined, and the auction result is displayed. In the Internet auction, when a supplier puts a good for sale on a website, a plurality of Internet users who are accessing the website bid for the good at the same time, and thus suppliers can sell their goods at a higher price or buyers can purchase the goods at a lower price. In Korea, electronic appliances, compact disk, computers, and books are purchased the most through online auctions, in this order.

A number of banner auction advertisements with different sizes can be seen on an Internet web page. A service provider of the web page can benefit from the advertisements and continuously offer the service. However, such auction advertisements appear on the web page regardless of auction time, and advertisement in a specific time period has not been considered so far.

### SUMMARY OF THE INVENTION

The present invention provides a method of auctioning an advertisement provided from a server to a client by using the time and the position of the advertisement to appear on the client as parameters, a recording medium therefor, and an advertisement auction system.

According to an aspect of the present invention, there is provided a method of auctioning an advertisement provided from a server to a client, the method comprising: receiving bidding information from a plurality of advertiser terminals connected to the server, the bidding information including time information which indicates the time when the advertisement will be displayed by the client; selecting one of advertiser terminals based on the time information included in the bidding information; and transmitting advertisement content sent to the client in response to a request of the selected advertiser terminal.

The advertisement content may be transmitted to the client according to the time information.

The bidding information may include bidding price information, and the selecting of one of the advertiser terminals may include determining the highest bidding price by prioritizing the time information and selecting an advertiser terminal which transmits bidding information which offers the highest bidding price.

The client may include an image display device.

The bidding information may include position information which indicates at which position the advertisement content will appear in the image display device.

The image display device may display a schedule management image including a calendar.

The position information may indicate a position corresponding to a predetermined date of the schedule management image and the advertisement content may be displayed as an icon.

The client may output the advertisement content to the image display device using a pop-up window when the client receives a signal that indicates the icon is selected.

According to another aspect of the present invention, there is provided a system of auctioning advertisement provided from a server to a client, the system comprising: a bidding information database which receives and stores bidding information from a plurality of advertiser terminals, the bidding information including time information that indicates the time when the advertisement will appear on the client; and a control unit which selects one of the advertiser terminals based on the time information included in the bidding information and transmits the advertisement content to the client in response to a request of the selected advertiser terminal.

The control unit may transmit the advertisement content to the client according to the time information.

The bidding information may include bidding price information, and the control unit may determine the highest bidding price by prioritizing the time information and select an advertiser terminal which transmits the bidding information offering the highest bidding price.

According to an auction method in an electronic commercial transaction, an effect of an advertisement varies with the time and position where the advertisement appears. Thus, if an auction is held for the time of the advertisement and a user bids for a particular period of time when the advertisement will appear and wins the auction, the user can maximize the effect of the advertisement. Also, since an auction server provider can have higher bidding prices offered for a particular period of time, the profit can be maximized.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an advertisement auction system according to an exemplary embodiment of the present invention;

FIG. 2 is a flowchart illustrating a method of auctioning an advertisement that a server provides to a client, according to an exemplary embodiment of the present invention;

FIGS. 3A and 3B are flowcharts illustrating a method of auctioning an advertisement provided to the client from the server, according to another exemplary embodiment of the present invention;

FIG. 4 shows an example of a schedule management image including a calendar, according to an exemplary embodiment of the present invention; and

FIG. 5 shows an example of a pop-up window according to an exemplary embodiment of the present invention.

### DETAILED DESCRIPTION OF EXEMPLARY EMBODIMENTS OF THE INVENTION

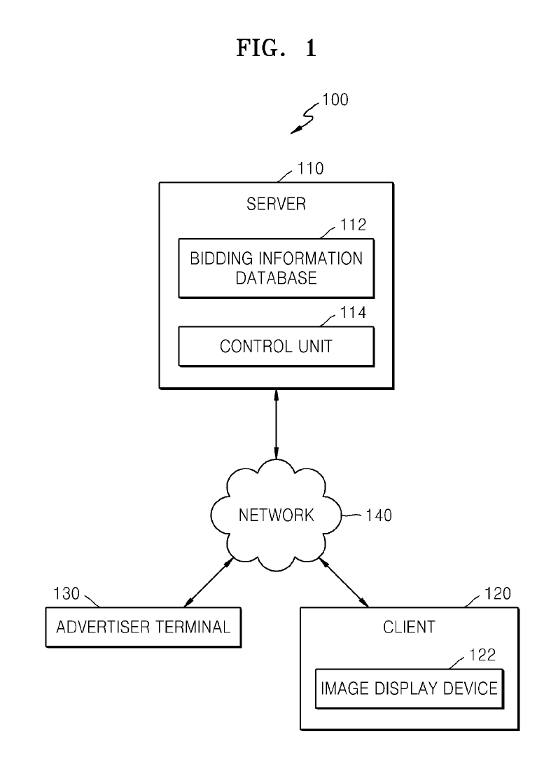

FIG. 1 is a block diagram of an advertisement auction system 100 according to an embodiment of the present invention. Referring to FIG. 1, the advertisement auction system 100 includes a server 110, a client 120, an advertiser terminal 130, and a network 140 that connects all these elements. The server 110 includes a bidding information database 112 and a control unit 114. The client 120 includes an image display device 122.

When a desired advertisement time is awarded to one of advertisers at auction which submit a bid using their advertiser terminals 130, the server 110 transmits advertisement contents of the successful bidder to the client 120. The server 110 may only permit access from authorized users. In the current embodiment of the present invention, the users are those who use the advertiser terminal 130 and the client 120. When the users register themselves in the server 110, they input their personal information, information of authorization, and a serial number of the advertiser terminal 130 which they own. The user can download the registered data only to his/her advertiser terminal 130. Also, the user can register a plurality of serial numbers of different advertiser terminals 130. The serial number is used as authentication information when the advertiser terminal 130 accesses the server 110 to download data. Hence, the user does not need to inconveniently input a user ID or a password every time when downloading data, and the data synchronization is automatically performed. According to an embodiment of the present invention, the serial number is used as a key each time data is downloaded. According to another embodiment of the present invention, the server 110 uses the serial number as a key phrase to create a key pair including a personal key and a public key. Then, when the advertiser terminal 130 of the user accesses the server 110 for the first time, the server 110 uploads the personal key, which corresponds to the serial number, to the advertiser terminal 130 and then removes the personal key from the server 110 so that all subsequent secured accesses to the server 110 can proceed according to a public key cryptography algorithm.

The bidding information database 112 stores bidding information including time information about when the advertisement received from the advertiser terminal 130 is to be shown. The bidding information may include information of the advertiser, a bidding price, and display position information of the image display device 122 of the client 120 where the advertisement is output. However, the present invention is not limited to any particular bidding information, and the bidding information can have any form or type as long as the bidding information relates to bidding. The time information may include the time when the advertiser wants to show the advertisement. For example, when the user wants the advertisement to appear between 4 and 6 p.m., the advertiser puts time interval information into the bidding information, and provides the information to the server 110. The time information may be dates or days (for example, from 1^{st} to 11^{th} of November or every Sunday) when the advertiser wants to show the advertisement. The time information also may include more a detailed time, for example, between 4 and 6 p.m. every Saturday from November 2007.

The control unit 114 receives the bidding information stored in the bidding information database 112. The control unit 114 determines which bidder wins the auction based on the time information included in the received bidding information, and transmits content of the winner's advertisement to the client 120. The criteria of deciding the winner can be predetermined by the control unit 114. Specifically, the duration of auction, that is, the duration from the bidding start time to the bidding end time, can be set by the server 110. The control unit 114 may set priorities among the bidding information. In the current embodiment, the control unit 114 may give priority to the time information among the bidding information received from a plurality of adviser terminals 130 and determine the advertiser terminal 130 of a user offering the highest bidding price. When the server 110 determines a single advertiser terminal 130, the server 110 transmits winning information corresponding to the bidding information together with the advertisement content to the client 120. In this case, the server 110 transmits the advertisement content to the client 120 based on the time information. For example, if the advertiser submits the time information which includes the time between 4 and 6 p.m. and wins the auction, the server 110 may transmit content of the advertisement to the client 120 at the desired time.

The advertiser terminal 130 may be a personal computer, a personal digital assistant, or a mobile phone which is connected to the network 140. However, the present invention is not limited to the above-mentioned devices, and thus any device can be employed as long as the device has an input means and is connectable to the server 110 over the network 140. The advertiser terminal 130 may be desirably a personal computer connected to the server 110 over the network 140. The advertiser terminal 130 transmits bidding information made by the advertiser to the server 110 through the network 140. When the server 110 determines one advertiser terminal 130 of different advertisers based on the bidding information which satisfies the winning criteria, the winning advertiser terminal 130 transmits content of the advertisement to the server 110. In another embodiment of the present invention, the content of the advertisement may be initially included in the bidding information and transmitted to the server 110.

The client 120 is connected to the server 110 through the network 140, and is a device including the image display device 122 having a display unit (not shown). For example, the client 120 may be a personal computer, a personal digital assistant (PDA), a mobile phone, a television, a cable television, an Internet protocol TV, a digital media broadcasting (DMB) device, or an electronic calendar device which is connected over a wireless/wired network or broadcasting network. The electronic calendar device is capable of displaying a schedule management image like a calendar table. Also, the electronic calendar device can have other functions, and may be connected to devices (for example, a personal computer or television), which is connected to the network 140, through, for example, a USB (universal serial bus) port of the device. Furthermore, the electronic calendar device can be charged through the USB port or can be connected to an electric power through a power supply adaptor.

If the client 120 is the image display device 122 which displays the schedule management image including a calendar, the control unit 114 commands the advertisement to be shown in a predetermined date column of the schedule management image by issuing a command to display the advertisement as an icon. When the control unit 114 receives a signal which indicates that the icon has been selected, the control unit 114 issues a command to the client 120 so as to output the content of the advertisement as a pop-up window. The pop-up window may include information of a user who has made the schedule, detailed content of the advertisement, a user related to the schedule, and audio data, image or moving pictures uploaded by the user. In another embodiment of the present invention, when the client 120 is connected to the Internet, the control unit 114 may show a web page to which the icon is hyperlinked when the control unit 114 receives the signal that indicates the icon has been selected.

The network 140 connects the server 110, the client 120, and a plurality of advertiser terminals 130 with one another. The network 140 may be the Internet. However, the present invention is not limited to the Internet, and the network may be a wired communication network, a wireless communication network such as Bluetooth, WI-Fi, or an ultra mobile broadband (UMB), or a broadcasting network.

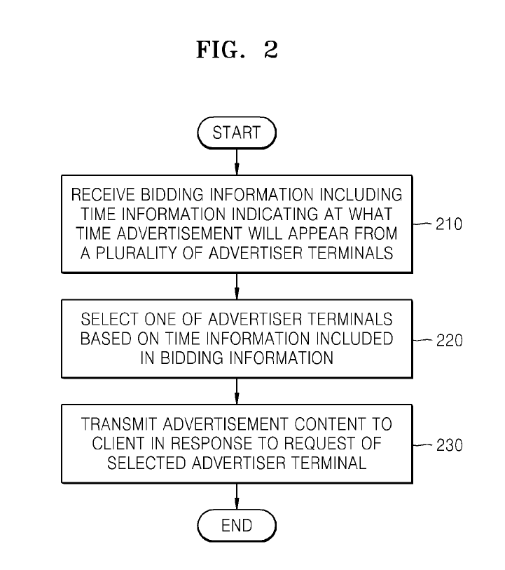

FIG. 2 is a flowchart illustrating a method of auctioning an advertisement that a server 110 provides to a client, according to an embodiment of the present invention. Referring to FIG. 2, in operation 210, the server 110 receives bidding information from a plurality of advertiser terminals 130 connected to the server 110 through the wired/wireless network or a broadcasting network, the bidding information including time information that contains the time when the advertisement is desired to appear. An advertiser accesses the server through the advertiser terminal, and transmits the bidding information relevant to the auction to the server. In the current embodiment, when the advertiser terminal is connected to the server 110, the server may require bidding information including information about the bidder (for example, ID of the bidder or identification information of a company or person), time information indicating what time the bidder wants the advertisement to appear (for example, the advertisement time: between 6 and 8 p.m.) bidding price information, and a position where the advertisement appears (for example, top of the display of the client). However, the present invention is not limited to the above-mentioned bidding information, and any bidding information can be employed as long as the information is related to bidding. Subsequently, the advertiser completes the bidding information relating to the bidding requirements using the advertiser terminal, and transmits the complete bidding information to the server. At this time, the advertiser can attach content of his advertisement to the bidding information and transmit it. The content of the advertisement may be a still image or moving pictures. Alternatively, the content may include only audio files.

In operation 220, the server selects one of advertiser terminals based on the time information included in the bidding information received from a plurality of advertiser terminals. The time information may be considered the most important factor among the bidding information to determine the winner of the auction, and the bidding price may be the second important factor. An advertiser terminal which submits the highest bidding price for the corresponding time will be determined as the winner. For example, when the server announces a bidding notice of sale of the advertisement time between 6 and 8 p.m., a first advertiser submits a bid of 50,000 won for the time between 6 and 8 p.m., a second advertiser submits a bid of 45,000 won for the time between 6 and 8 p.m., and a third advertiser submits a bid of 55,000 won for the time between 5 and 7 p.m., the server chooses the first advertiser giving priority to the time information. If there is no advanced bidding announcement, the server may choose the third advertiser which offers the highest bidding price. In this case, the sale by auction for advertisement at the time between 5 and 7 p.m. is completed, and auction for the remaining time will be continued. In the current embodiment of the present invention, the auction takes place to sell a particular time period for advertisement. When the server 110 chooses one of the advertiser terminals, the server 110 sends the advertiser terminal a notification regarding winning of the auction. Then, the advertiser terminal transmits content of the advertisement to the server. Transmission of the advertisement content is not necessary if the content is already included in the bidding information.

In operation 230, the server transmits the content of the advertisement of the selected advertiser terminal to the client. At this time, the server may transmit successful bidding information which corresponds to the bidding information including the time information. The server may transmit the content of the advertisement to the client at the time indicated by the time information. Subsequently, the client outputs the content of the advertisement at the time indicated by the time information. When the client has an image display device, the client displays the content of the advertisement on the image display device.

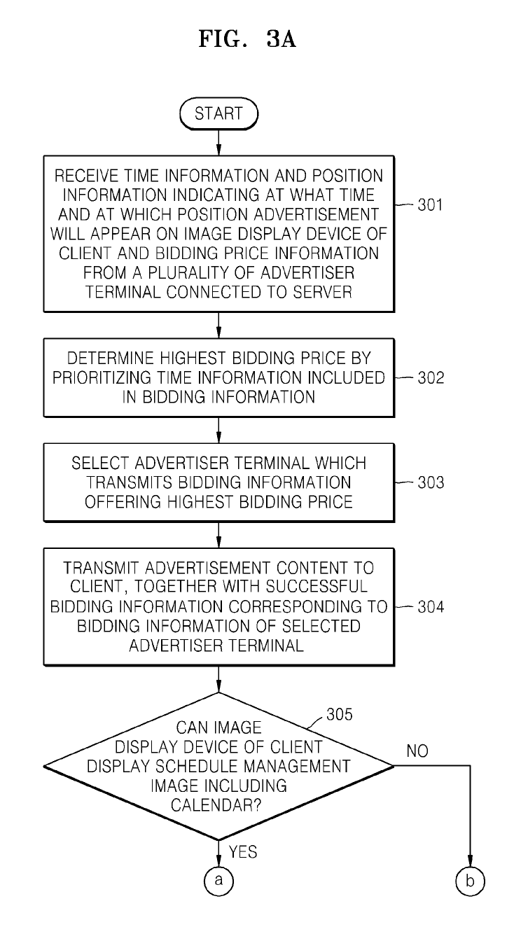

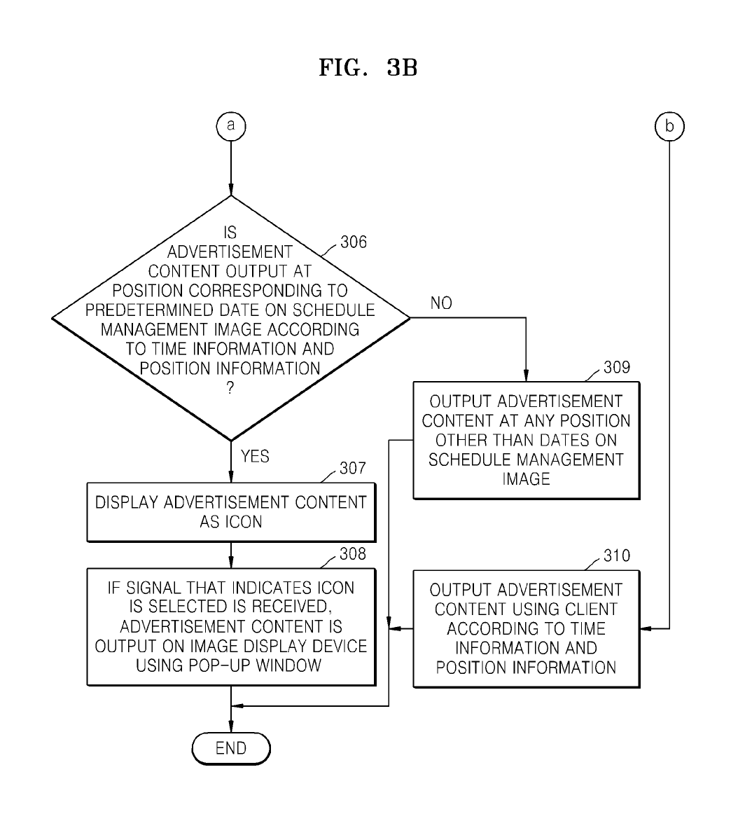

FIGS. 3A and 3B are flowcharts illustrating a method of auctioning an advertisement provided to the client from the server, according to another embodiment of the present invention. FIG. 3B is a continuation flowchart of FIG. 3A.

Since operations 301 to 304 in FIG. 3A are similar to those of FIG. 2, detailed descriptions of these operations will be omitted.

Referring to FIGS. 3A and 3B, in operation 305, when the client receives the advertisement content from the server, the client having the image display device determines whether or not the image display device can display a schedule management image including a calendar. If the image display device can display the schedule management image including the calendar, the method proceeds to operation 306. Otherwise, the method proceeds to operation 310. In operation 310, the client outputs the content of the advertisement at a particular time, or at a particular time and at a particular position according to time information or position information.

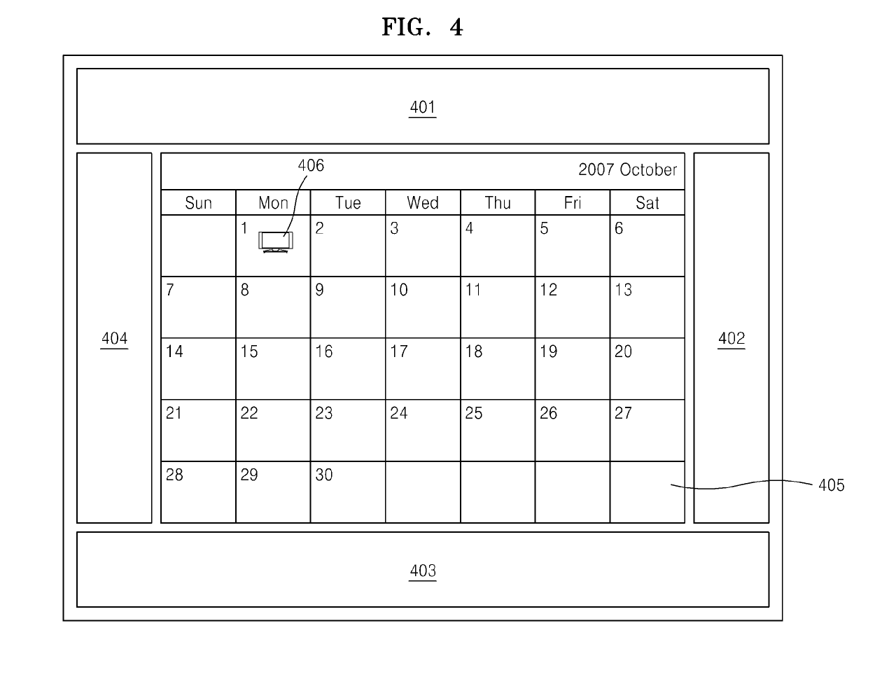

In operation 306, it is determined whether the advertisement content is output at a predetermined position which corresponds to a predetermined date of the schedule management image according to the time information and the position information. If the advertisement content is output at the position corresponding to the predetermined date of the schedule management image, the method proceeds to operation 307. Otherwise, the method proceeds to operation 309. In operation 309, the advertisement content is output at any position other than a position corresponding to the date on the schedule management image. FIG. 4 shows an example of the schedule management image including a calendar, according to an embodiment of the present invention. Referring to FIG. 4, the advertisement is output at any sections 401, 402, 403, and 404. There is no limitation on the number of sections where the advertisement is output. Also, the advertisement can be output at a box 405 of the calendar image as long as dates are not displayed in the box. Thus, the advertisement can be output at any position other than where the calendar image is output, but also even at a position corresponding to a predetermined date (for example, 1^{st} of October) of the calendar image. In operation 309, the advertisement content can be output at any of sections 401, 402, 403, 404, and 405.

In operation 307, the advertisement content is output as an icon at a predetermined date column. An icon is a small picture or object which represents a program, command, or data file so as to facilitate recognition of the program, command or data file. In the present invention, the icon may represent the content of the advertisement or information of the advertiser's company or goods to be advertised. Since the column for the date has comparatively small space, it is more suitable to display the advertisement content as an icon. Referring to FIG. 4, a television-shaped icon 406 is displayed at the date column of 1^{st} of October to advertise a television.

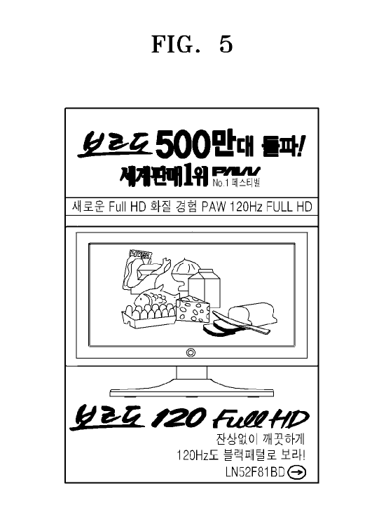

In operation 308, when the image display device receives a signal which indicates the icon is selected, the image display device outputs the advertisement content using a pop-up window. FIG. 5 shows an example of a pop-up window according to an embodiment of the present invention. According to another embodiment, when the image display device receives a signal which indicates the icon is selected, the image display device may move to a web page, which is hyperlinked to the icon, and output the advertisement content to its display.

The method of auctioning an advertisement provided to a client from a server can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices. The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of auctioning an advertisement provided from a server to a client, the method comprising:
receiving bidding information from a plurality of advertiser terminals connected to the server, the bidding information including time information which indicates the time when the advertisement will be displayed by the client;
selecting one of the advertiser terminals based on the time information included in the bidding information; and
transmitting advertisement content sent to the client in response to a request of the selected advertiser terminal.

2. The method of claim 1, wherein the advertisement content is transmitted to the client according to the time information.

3. The method of claim 1, wherein the bidding information comprises bidding price information, and the selecting of one of the advertiser terminals comprises determining the highest bidding price by prioritizing the time information and selecting an advertiser terminal which transmits bidding information which offers the highest bidding price.

4. The method of claim 1, wherein the client comprises an image display device.

5. The method of claim 4, wherein the bidding information comprises position information which indicates a position where the advertisement content will appear on the image display device.

6. The method of claim 5, wherein the image display device displays a schedule management image including a calendar.

7. The method of claim 6, wherein the position information indicates a position corresponding to a predetermined date of the schedule management image and the advertisement content is displayed as an icon.

8. The method of claim 7, wherein the client outputs the advertisement content to the image display device using a pop-up window when the client receives a signal that indicates the icon is selected.

9. A computer readable recording medium encoded with the method of claim 1 and implemented by a computer.

10. A system of auctioning an advertisement provided from a server to a client, the system comprising:
a bidding information database which receives and stores bidding information from a plurality of advertiser terminals, the bidding information including time information that indicates what time the advertisement will appear on the client; and
a control unit which selects one of the advertiser terminals based on the time information included in the bidding information and transmits the advertisement content to the client in response to a request of the selected advertiser terminal.

11. The system of claim 10, wherein the control unit transmits the advertisement content to the client according to the time information.

12. The system of claim 10, wherein the bidding information comprises bidding price information, and the control unit determines the highest bidding price by prioritizing the time information and selects an advertiser terminal which transmits the bidding information that offers the highest bidding price.

13. The system of claim 10, wherein the client comprises an image display device.

14. The system of claim 13, wherein the bidding information comprises position information which indicates a position where the advertisement content will appear in the image display device.

15. The system of claim 14, wherein the image display device displays a schedule management image including a calendar.

16. The system of claim 15, wherein the position information indicates a position corresponding to a predetermined date of the schedule management image and the advertisement content is displayed as an icon.

17. The system of claim 16, wherein the client outputs the advertisement content to the image display device using a pop-up window when the client receives a signal that indicates the icon is selected.
